(19) United States
(12) Patent Application Publication
(10) Pub. No.: US 2008/0233350 A1
(43) Pub. Date: Sep. 25, 2008

(54) STRUCTURED PERFORATED PLASTIC SHEET

(76) Inventor: Chen-Cheng Huang, Taipei City (TW)

Correspondence Address: BUTZEL LONG;IP DOCKETING DEPT, 350 SOUTH MAIN STREET, SUITE 300, ANN ARBOR, MI, 48104, US

(21) Appl. No.: 12/050,262

(22) Filed: Mar. 18, 2008

(30) Foreign Application Priority Data
Mar. 19, 2007 (TW) 096109332

(51) Int. Cl. B32B 3/24; B32B 3/10

(52) U.S. Cl. 428/137; 428/131

(57) ABSTRACT

A structured perforated plastic sheet includes a plastic sheet body having a tri-layer configuration that includes a planar top layer of a top net-like structure, a planar middle layer of a middle net-like structure that is disposed below and that is parallel to the top net-like structure, and a planar bottom layer of a bottom net-like structure that is disposed below and that is parallel to the middle net-like structure.

### CROSS-REFERENCE TO RELATED APPLICATION

This application claims priority of Taiwanese Application No. 096109332, filed on Mar. 19, 2007.

### BACKGROUND OF THE INVENTION

1. Field of the invention

This invention relates to a structured perforated plastic sheet, more particularly to a structured perforated plastic sheet having a tri-layer configuration.

2. Description of the related art

U.S. Patent Application Publication No. 20040043189 discloses a structured perforated plastic sheet that can be used as a wearer-contacting topsheet of an absorptive device, such as diapers and bandages, a water-retaining agent for agricultural applications, and sanitary napkins, or a as packaging or a decorative material. The structured perforated plastic sheet has a bi-layer configuration including a top layer of a net-like structure and a bottom layer of a net-like structure. The net-like structure of the top layer defines a plurality of top holes. The net-like structure of the bottom layer defines a plurality of bottom holes. Each of the top holes has an area much larger than that of each of the bottom holes, and overlies plural ones of the bottom holes. The net-like structure of the top layer can serve to break a liquid body into smaller portions and distribute them among the top holes, thereby enhancing distribution of the liquid among the bottom holes.

### SUMMARY OF THE INVENTION

An object of the present invention is to provide a structured perforated plastic sheet having a tri-layer configuration that can further enhance distribution of a liquid body and thereby promote transport of the liquid body.

According to the present invention, a structured perforated plastic sheet comprises a plastic sheet body having a tri-layer configuration that includes a planar top layer of a top net-like structure, a planar middle layer of a middle net-like structure that is disposed below and that is parallel to the top net-like structure, and a planar bottom layer of a bottom net-like structure that is disposed below and that is parallel to the middle net-like structure. The top net-like structure is formed with a pattern of top holes, each of which is defined by a top hole-defining wall. The middle net-like structure is formed with a pattern of middle holes, each of which is defined by a middle hole-defining wall. The bottom net-like structure is formed with a pattern of bottom holes, each of which is defined by a bottom hole-defining wall. Each of the top and middle holes has an area greater than that of each of the bottom holes. Each of the top hole-defining walls intersects at least one of the middle hole-defining walls and plural ones of the bottom hole-defining walls therebelow and is connected to the at least one of the middle hole-defining walls and the plural ones of the bottom hole-defining walls at the intersections thereof. Each of the middle hole-defining walls intersects plural ones of the bottom hole-defining walls therebelow and is connected to the plural ones of the bottom hole-defining walls at the intersections thereof.

### BRIEF DESCRIPTION OF THE DRAWINGS

In drawings which illustrate an embodiment of the invention,

FIG. 1 is a fragmentary schematic top view of the preferred embodiment of a structured perforated plastic sheet according to this invention; and

FIG. 2 is a fragmentary perspective view of the preferred embodiment.

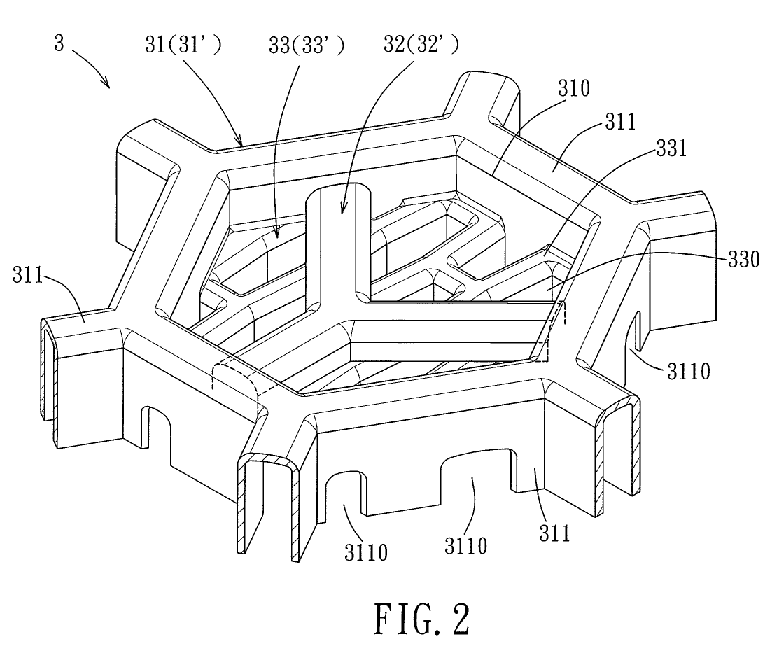

### DETAILED DESCRIPTION OF THE PREFERRED EMBODIMENT

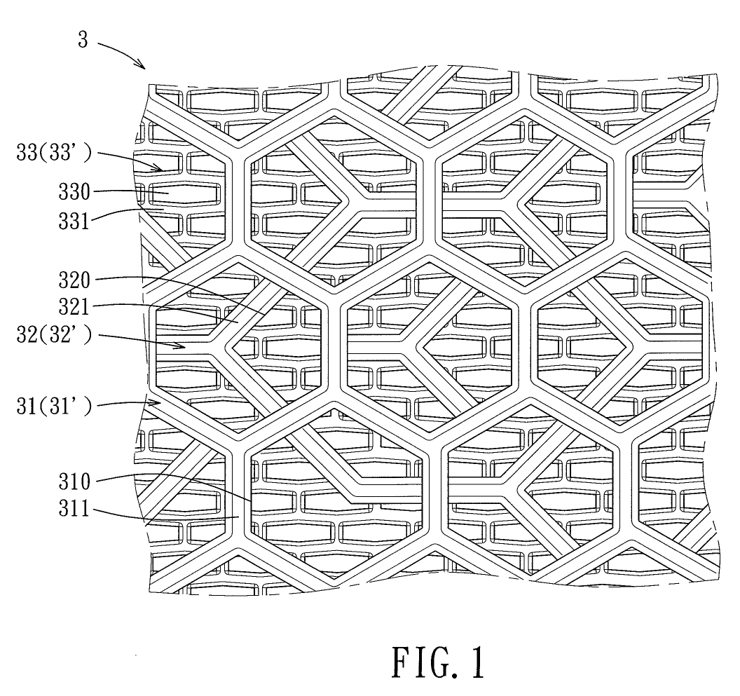

FIG. 1 illustrates the preferred embodiment of a structured perforated plastic sheet according to this invention. The structured perforated plastic sheet can be used as a wearer-contacting topsheet of an absorptive device, such as diapers and bandages, a water-retaining agent for agricultural applications, and sanitary napkins, or as a packaging or a decorative material, and includes a plastic sheet body 3 having a tri-layer configuration that includes a planar top layer 31′ of a top net-like structure 31, a planar middle layer 32′ of a middle net-like structure 32 that is disposed below and that is parallel to the top net-like structure 31, and a planar bottom layer 33′ of a bottom net-like structure 33 that is disposed below and that is parallel to the middle net-like structure 32. The top net-like structure 31 is formed with a pattern of top holes 310, each of which is defined by a polygonal top hole-defining wall 311. The middle net-like structure 32 is formed with a pattern of middle holes 320, each of which is defined by a polygonal middle hole-defining wall 321. The bottom net-like structure 33 is formed with a pattern of bottom holes 330, each of which is defined by a polygonal bottom hole-defining wall 331. Each of the top and middle holes 310, 320 has an area greater than that of each of the bottom holes 330. Each of the top hole-defining walls 311 intersects at least one of the middle hole-defining walls 321 and plural ones of the bottom hole-defining walls 331 therebelow and is directly and integrally connected to said at least one of the middle hole-defining walls 321 and the plural ones of the bottom hole-defining walls 331 at the intersections thereof. Each of the middle hole-defining walls 321 intersects plural ones of the bottom hole-defining walls 331 therebelow and is directly and integrally connected to the plural ones of the bottom hole-defining walls 331 at the intersections thereof. The tri-layer configuration of the plastic sheet body 3 is capable of breaking a liquid body (not shown) into smaller portions through the net-like structures 31, 32 of the top and middle layers 31′, 32′, thereby enhancing distribution and transport of the liquid body from the top layer 31′ to the bottom layer 33′.

In this embodiment, each of the top hole-defining walls 311 is formed with at least one side hole 3110 that is in spatial communication with two adjacent ones of the bottom holes 330 so as to enhance distribution and transport of the liquid body from the top net-like structure 31 of the top layer 31′ into the bottom net-like structure 33 of the bottom layer 33′.

Preferably, each of the bottom holes 330 has a diameter less than 1 mm, and is tapered in a direction away from the middle layer 32′.

With the tri-layer configuration and with the inclusion of the side hole(s) 3110 in the top net-like structure 31 of the top layer 31′ of the structured perforated plastic sheet of this invention, distribution and transport of a liquid body can be enhanced.

With the invention thus explained, it is apparent that various modifications and variations can be made without departing from the spirit of the present invention. It is therefore intended that the invention be limited only as recited in the appended claims.

What is claimed is:

1. A structured perforated plastic sheet comprising:
a plastic sheet body having a tri-layer configuration that includes a planar top layer of a top net-like structure, a planar middle layer of a middle net-like structure that is disposed below and that is parallel to said top net-like structure, and a planar bottom layer of a bottom net-like structure that is disposed below and that is parallel to said middle net-like structure, said top net-like structure being formed with a pattern of top holes, each of which is defined by a top hole-defining wall, said middle net-like structure being formed with a pattern of middle holes, each of which is defined by a middle hole-defining wall, said bottom net-like structure being formed with a pattern of bottom holes, each of which is defined by a bottom hole-defining wall, each of said top and middle holes having an area greater than that of each of said bottom holes, each of said top hole-defining walls intersecting at least one of said middle hole-defining walls and plural ones of said bottom hole-defining walls therebelow and being connected to said at least one of said middle hole-defining walls and said plural ones of said bottom hole-defining walls at the intersections thereof, each of said middle hole-defining walls intersecting plural ones of said bottom hole-defining walls therebelow and being connected to said plural ones of said bottom hole-defining walls at the intersections thereof.

2. The structured perforated plastic sheet of claim 1, wherein each of said bottom holes is tapered in a direction away from said middle layer.

3. The structured perforated plastic sheet of claim 1, wherein each of said bottom holes has a diameter less than 1 mm.

4. The structured perforated plastic sheet of claim 1, wherein each of said top hole-defining walls is formed with at least one side hole that is in spatial communication with two adjacent ones of said bottom holes.
